(19) United States
(12) Patent Application Publication
(10) Pub. No.: US 2025/0102107 A1
(43) Pub. Date: Mar. 27, 2025

(54) Equipment Retention Systems and Methods

(71) Applicant: Rad Innovations LLC, Riverton, WY (US)

(72) Inventor: David O. Merrill, JR., Riverton, WY (US)

(21) Appl. No.: 18/893,227

(22) Filed: Sep. 23, 2024

Related U.S. Application Data
(60) Provisional application No. 63/584,770, filed on Sep. 22, 2023.

(51) Int. Cl. F16M 13/02; F41B 5/14; F41C 33/00

(52) U.S. Cl. CPC F16M 13/02; F41B 5/1453; F41C 33/006

(57) ABSTRACT

An equipment retention system is provided for selective hands-free retention of an object. In one example, the equipment retention system includes a receiver having a first component and a second component secured to the first component. The system may further include a mounting post having a first end and a second end. In one example, the mounting post selectively engages with the receiver via the first end and is fixedly secured to a piece of equipment via the second, opposite, end. In one example, the receiver defines a substantially Y-shaped opening configured to selectively receive the first end of the mounting post. In another example, upon insertion of the first end of the mounting post into the Y-shaped opening, the mounting post is locked within the Y-shaped opening via engagement between the mounting post and an angled protrusion extending away from the second component of the receiver.

### CROSS-REFERENCE TO RELATED APPLICATIONS

This application claims the benefit of U.S. Provisional Application No. 63/584,770, filed Sep. 22, 2023, which is hereby incorporated by reference in its entirety.

### BACKGROUND

Equipment retention systems may be used to retain (e.g., hold and/or support) an object (e.g., an archery bow, crossbow, firearm, optics, and/or other piece of equipment). However, typical equipment retention systems often utilize one or more moving components, which may result in failure of the equipment retention system, especially during intense use and/or use in inclement environments.

### SUMMARY

Some aspects of the disclosure provide an equipment retention system for selective hands-free retention of an object. In one example, the equipment retention system includes a receiver having a first component and a second component secured to the first component. The system may further include a mounting post having a first end and a second end. In one example, the mounting post selectively engages with the receiver via the first end and is fixedly secured to a piece of equipment via the second, opposite, end. In one example, the receiver defines a substantially Y-shaped opening configured to selectively receive the first end of the mounting post. In another example, upon insertion of the first end of the mounting post into the Y-shaped opening, the mounting post is locked within the Y-shaped opening via engagement between the mounting post and an angled protrusion extending away from the second component of the receiver.

Some aspects of the disclosure provide a method of using an equipment retention system. The method can include arranging a head of a mounting post within a gap defined by a receiver, with the head of the mounting post positioned below an angled portion of the gap of the receiver, releasing the mounting post to permit rotation of the head of the mounting post within the gap of the receiver in a first direction to move the mounting post into a first position, and preventing removal of the mounting post from the gap of the receiver via contact between the head of the mounting post and the angled portion of the gap of the receiver when in the first position.

Some aspects of the disclosure provide an equipment retention system. The equipment retention system can include a mounting post having a head defining a first end, a neck secured to and extending away from the head, and a body secured to and extending from the neck, the body defining a second end configured to retain an object. The equipment retention system can further include a receiver to selectively receive and retain the mounting post. The receiver can include a first component and a second component secured to the first component, the first component and the second component together defining a gap to receive the head of the mounting post, and the second component defining a chamfered edge to guide the mounting post into the gap. The second component can include a stepped inner surface having an angled protrusion extending within the gap, towards the first component, the angled protrusion to contract the head of the mounting post to selectively retain the mounting post within the gap.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a perspective view of an example equipment retention system according to aspects of the present disclosure.

FIG. 2 is a perspective view of a receiver of the equipment retention system of FIG. 1.

FIG. 3 is a front view of the receiver of FIG. 2.

FIG. 4 is a rear view of the receiver of FIG. 2.

FIG. 5 is a cross-sectional view of the receiver of FIG. 2.

FIG. 6 is an exploded view of the receiver of FIG. 2.

FIG. 7 is a front interior view of a first component of the receiver of FIG. 6.

FIG. 8 is a side view of the first component of the receiver of FIG. 7.

FIG. 9 is a rear interior view of a second component of the receiver of FIG. 6.

FIG. 10 is a cross-sectional view of the second component of the receiver of FIG. 9.

FIG. 11 is a perspective view of another example of a receiver for use with the equipment retention system of FIG. 1.

FIG. 12 is a front view of a second component of the receiver of FIG. 11.

FIG. 13 is a rear interior view of the second component of the receiver of FIG. 12.

FIG. 14 is a cross-sectional view of the second component of the receiver of FIG. 12.

FIG. 15 is a front perspective view of a first component of the receiver of FIG. 11.

FIG. 16 is a rear perspective view of the first component of the receiver of FIG. 15.

FIG. 17 is an exterior perspective view of a clip for use with the equipment retention system of FIG. 1.

FIG. 18 is an interior perspective view of the clip of FIG. 17.

FIG. 19 is a perspective view of a mounting post for use with the equipment retention system of FIG. 1.

FIG. 20 is a side view of another example of a mounting post for use with the equipment retention system of FIG. 1.

FIG. 21 is a rear perspective view of the mounting post of FIG. 20.

FIG. 22 is a cross-sectional view of the equipment retention system of FIG. 1 in the locked position.

FIG. 23 is a cross-sectional view of the equipment retention system of FIG. 1 in the unlocked position.

FIG. 24 is a side view of another example of a mounting post for use with the equipment retention system of FIG. 1.

FIG. 25 is a front perspective view of a clamp of the mounting post of FIG. 24.

FIG. 26 is rear perspective view of the clamp of the mounting post of FIG. 25.

FIG. 27 is a bottom perspective view of the clamp of the mounting post of FIG. 25.

FIG. 28 is a front perspective view of a base of the mounting post of FIG. 24.

FIG. 29 is a rear perspective view of the base of the mounting post of FIG. 28.

FIG. 30 is a rear perspective view of a spacer of the mounting post of FIG. 24.

FIG. 31 is a front perspective view of the spacer of the mounting post of FIG. 30.

FIG. 32 is a side view of the spacer of the mounting post of FIG. 30.

FIG. 33 is a front perspective view of a post of the mounting post of FIG. 24.

FIG. 34 is a rear perspective view of the post of the mounting post of FIG. 33.

FIG. 35 is a side view of the post of the mounting post of FIG. 33.

FIG. 36 is a bottom view of the post of the mounting post of FIG. 33.

FIG. 37 is a perspective view of an example of a mounting pin for use with the equipment retention system of FIG. 1.

FIG. 38 is a perspective view of another example of a mounting pin for use with the equipment retention system of FIG. 1.

FIG. 39 is a perspective view of an example of a mounting post assembly for use with the equipment retention system of FIG. 1.

FIG. 40 is a front view of another example of a receiver for use with the equipment retention system of FIG. 1.

FIG. 41 is a side view of the receiver of FIG. 40.

FIG. 42 is a cross-sectional view of the receiver of FIG. 40.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In one example, an equipment retention system may include a receiver and a mounting post configured to selectively engage the receiver. The receiver may define an opening and/or slot configured to selectively receive a head of the mounting post. In one example, the receiver may enable the mounting post to actuate between a locked position and an unlocked position, which may permit and/or prevent separation of the mounting post and the receiver. In one example, the receiver may include a first component and a second component secured together via one or more fasteners to form a gap between the first and second component. In one example, the head of the mounting post may rest within the gap of the receiver to secure the mounting post to the receiver. Thus, as a user inserts the head of the mounting post into the opening and/or slot, the head slides within the gap and may be trapped between the first and second components of the receiver.

In one example, the second component includes an interior surface adjacent the gap. The interior surface may include a pair of parallel and offset vertical surfaces connected by an angled surface. In one example, the angled surface may protrude into the gap such that, in the locked position, the head of the mounting post may contact the angled surface to prevent removal of the mounting post from the receiver. Thus, in the locked position, the mounting post may pivot such that a rim of the head abuts the angled surface during vertical movement of the mounting post, which prevents removal of the mounting post from the receiver.

To move the mounting post into the unlocked position, the user may apply pivot and/or rotate the mounting post such that the head of the mounting post pivots within the gap. As the head of the mounting post pivots away from the angled surface, vertical movement of the mounting post may be unlocked. Put differently, the rim of the head of the mounting post may avoid contact with the angled surface and pass through the opening and/or slot and out of the receiver. Thus, the user may selectively lock and/or unlock relative movement between the mounting post and the receiver for hands-free equipment retention, without the need for additional components (e.g., biasing elements, etc.), which may extend the overall lifetime of the system.

In one particular example, the mounting post may be secured to a piece of archery equipment to enable a user to carry archery equipment into the field without needing to occupy one or more hands. Additionally, the equipment retention system may assist in weight mitigation and/or aid in reducing overall fatigue when carrying archery equipment into the field. For example, the equipment retention system may enable a user to secure an archery bow, crossbow, optics, camera equipment, and/or firearms. Further, the receiver may be configured to mount in a variety of ways to a variety of surfaces. For example, the receiver may include one or more slots configured to enable a user to secure the receiver to a portion of a vehicle, clothing, backpack, and/or other object via one or more straps (e.g., hook and loop type straps). In another example, the receiver may include one or more clips configured to enable a user to secure the receiver to a belt, one or more MOLLE loops, and/or a strap. The receiver may further include one or more apertures and/or keyhole slots configured to enable a user to mount the receiver to a wall, tree, and/or other object via one or more fasteners arranged through the aperture.

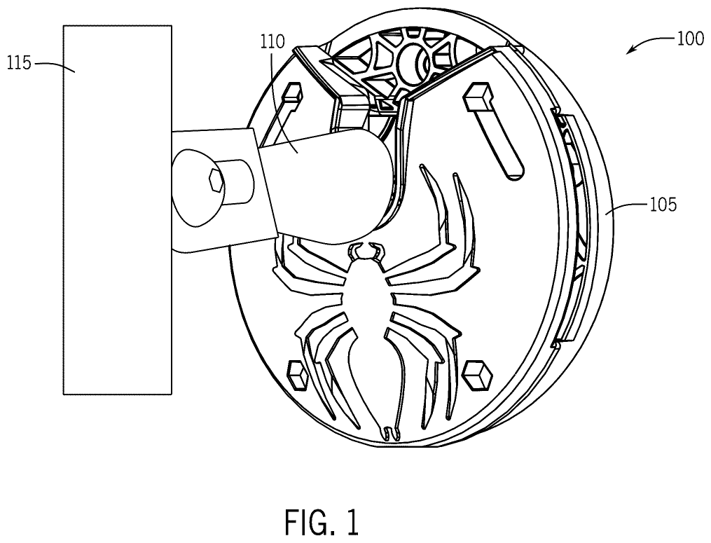

FIG. 1 illustrates one example of an equipment retention system 100. The equipment retention system 100 may include a receiver 105 and a mounting post 110 configured to selectively engage the receiver 105. In one example, the mounting post 110 may be secured to an object 115. For example, the mounting post 110 may be secured to a tool, archery bow, crossbow, firearm, optical device (e.g., rangefinder, binoculars, spotting scope, camera, etc.), and/or any other object. In one example, the equipment retention system 100 may enable a user to carry the object 115 hands-free. For example, a user may secure the object 115 via the mounting post 110 to the receiver 105 such that the receiver 105 supports the object 115. In one example, the receiver 105 may retain the mounting post 110 via an interference fit between the receiver 105 and the mounting post 110. In another example, a user may selectively lock and/or unlock relative movement of the mounting post 110 with respect to the receiver 105 via rotation (e.g., pivoting) the mounting post 110 within the receiver 105.

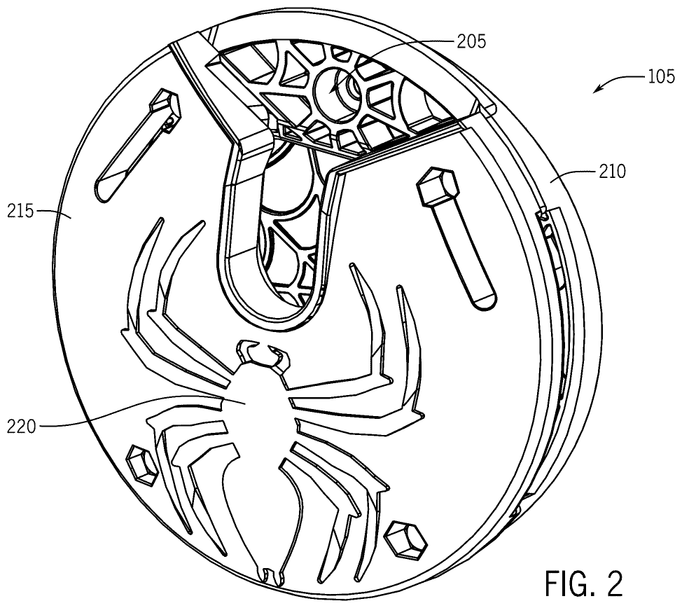

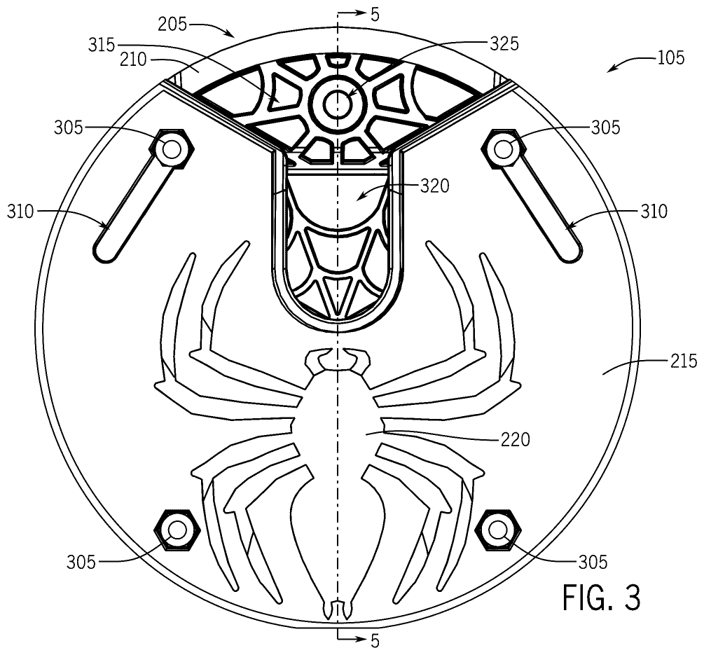

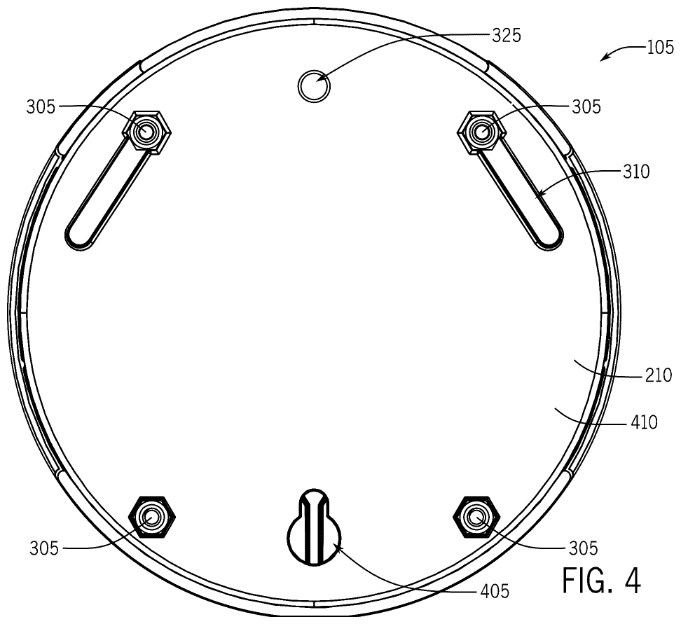

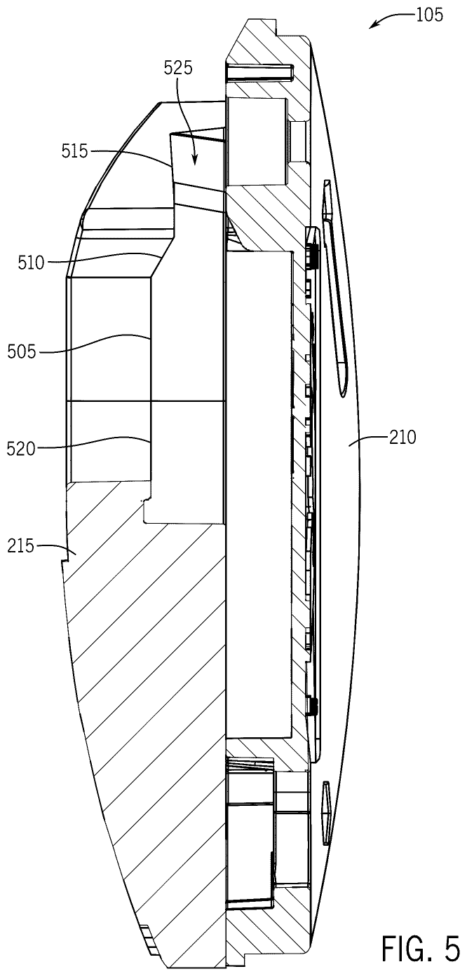

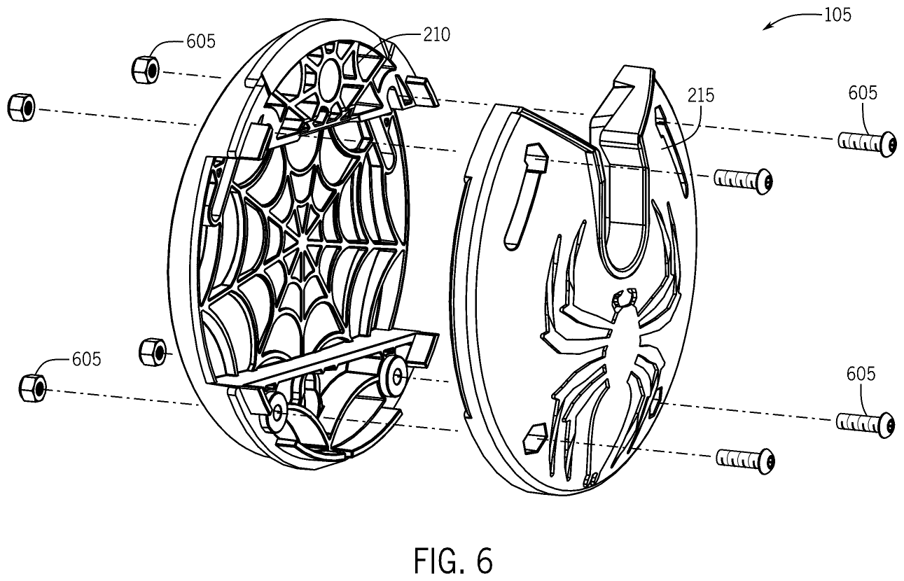

FIGS. 2-6 show various views of the receiver 105 of the equipment retention system 100. In one example, the receiver 105 may include clamshell type housing with a first component 210 and a second component 215 secured together via one or more fasteners 605 (e.g., nuts, bolts, screws, adhesive, rivets, welds, and/or any other known fasteners) arranged through one or more apertures 305. The receiver 105 may further include one or more slots 310 adjacent to the one or more apertures 305. In one particular example, the one or more slots 310 may extend into and form a portion of the one or more of the apertures 305. In one example, the slots 310 may extend through both the first component 210 and the second component 215 to allow a user to insert a strap (e.g., a hook and loop strap, corded strap, metallic strap, and/or any other known strap) through the slots 310 to serve as an optional mounting method for securing the receiver 105 to an object (e.g., a tree, backpack, vehicle seat, body of a user, and/or any other desired location). As another optional mounting method for the receiver 105, the receiver 105 may include an aperture 325 arranged through the first component 210. In one example, the aperture 325 may selectively receive a fastener to enable a user to secure the receiver 105 to an object (e.g., a tree, wall, and/or any other object). As another optional mounting method for the receiver 105, the receiver 105 may include a keyhole slot 405 positioned on an exterior surface 410 of the first component 210. The keyhole slot 405 may permit a user to secure the receiver 105 to a head of a fastener (e.g., a screw, nail, and/or any other fastener), while permitting rapid removal of the receiver 105 from the fastener via the keyhole slot 405.

In one example, the second component 215 may include one or more graphics 220 arranged on a face of the second component 215. The graphics 220 may display one or more images (e.g., marketing images, branding/logos, and/or text). In one example, both the first component 210 and the second component 215 may be made from the same material (e.g., polymeric material, metallic material, and/or any combination thereof). However, in other examples, the first component 210 and the second component 215 may be made from different materials (e.g., the first component 210 may be made from a polymeric material and the second component 215 may be made from a metallic material or vice versa).

In one example, the second component 215 of the receiver 105 may include an outer perimeter defining a Y-shaped opening 205 configured to selectively receive a portion of the mounting post 110. For example, a user may slide and/or insert a portion of the mounting post 110 into the opening 205 to secure the object 115 to the receiver 105. Correspondingly, the user may slide and/or remove the mounting post 110 from the opening 205 to remove the object 115 from the receiver 105.

As mentioned previously, the opening 205 may be substantially Y-shaped with a mouth portion 315 wider than a corresponding neck portion 320. The mouth portion 315 may assist a user in properly arranging the mounting post 110 within the opening 205. For example, the mouth portion 315 may include one or more chamfered edges angled towards the neck portion 320 to guide the mounting post 110 into the neck portion 320. In an example use, a user may slide a portion of the mounting post 110 along the chamfered edges of the mouth portion 315 until the mounting post 110 self-aligns with the neck portion 320 and slides within the neck portion 320 until contacting a valley of the neck portion 320. At this time, a user may release the mounting post 110 and/or object 115, which rotates the mounting post 110 within the receiver 105 and locks the mounting post 110 (and the object 115) within the receiver 105.

In one example, when secured together via the one or more fasteners 605, the first component 210 and the second component 215 form a gap 525 between an interior surface of the first component and an interior surface 520 of the second component 215. The gap 525 may be arranged adjacent to the opening 205 and configured to work with the opening 205 to receive a portion of the mounting post 110. In one example, the interior surface 520 of the second component 215 includes a series of stepped faces, which together form a locking mechanism for retaining the mounting post 110. For example, the interior surface 520, adjacent the opening 205, may include a first vertical portion 505, an angled portion 510, and a second vertical portion 515. In one example, the first vertical portion 505 and the second vertical portion 515 may each extend vertically, with the first vertical portion 505 and the second vertical portion 515 parallel to and offset from each other. Correspondingly, the angled portion 510 may extend at an acute angle away from the first vertical portion 505 to the second vertical portion 515. Put differently, the angled portion 510 may define a protrusion and/or shelf configured to contact a portion of the mounting post 110, which prevents inadvertent removal of the mounting post 110 from the receiver 105.

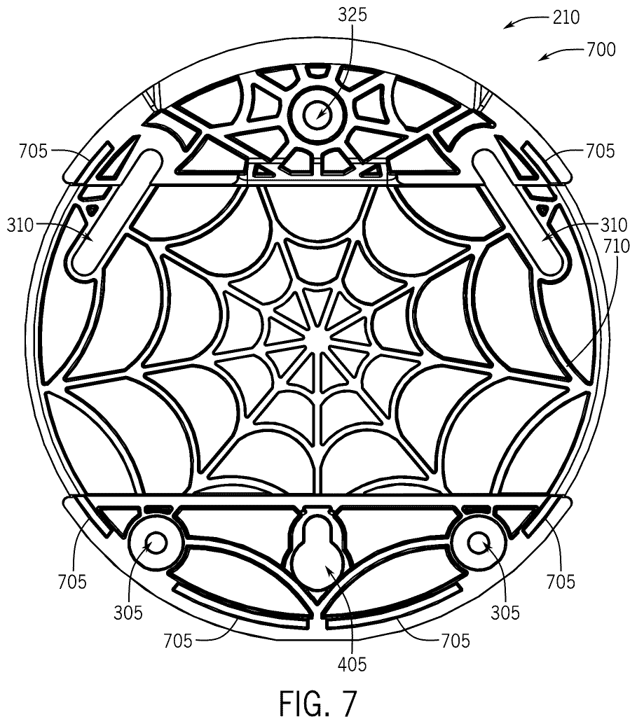

FIGS. 7-8 show an interior surface 700 of the first component 210, which may include one or more tabs 705 extending away from a pair of shelves 805 extending away from the interior surface 700 of the first component 210. In one example, the one or more tabs 705 may assist in alignment of the first component 210 with the second component 215 during assembly of the receiver 105. In another example, the one or more tabs 705 may provide additional strength to the receiver 105 when assembled (e.g., to resist shear forces between the first component 210 and the second component 215). The interior surface 700 of the first component 210 may further include one or more support ribs 710 to provide additional strength and/or rigidity to the first component 210 while reducing the overall weight of the first component 210.

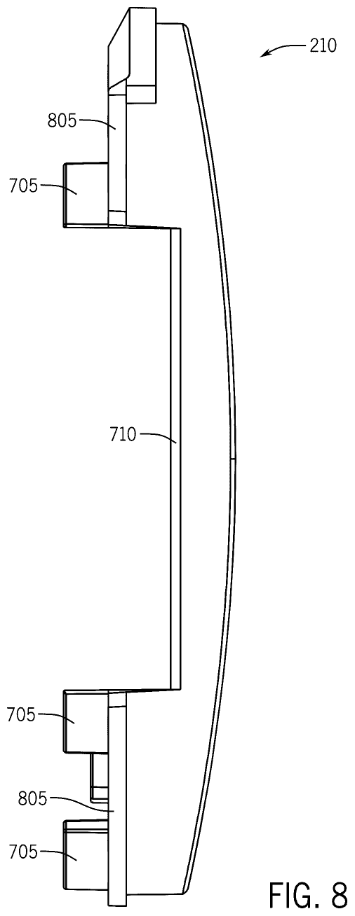

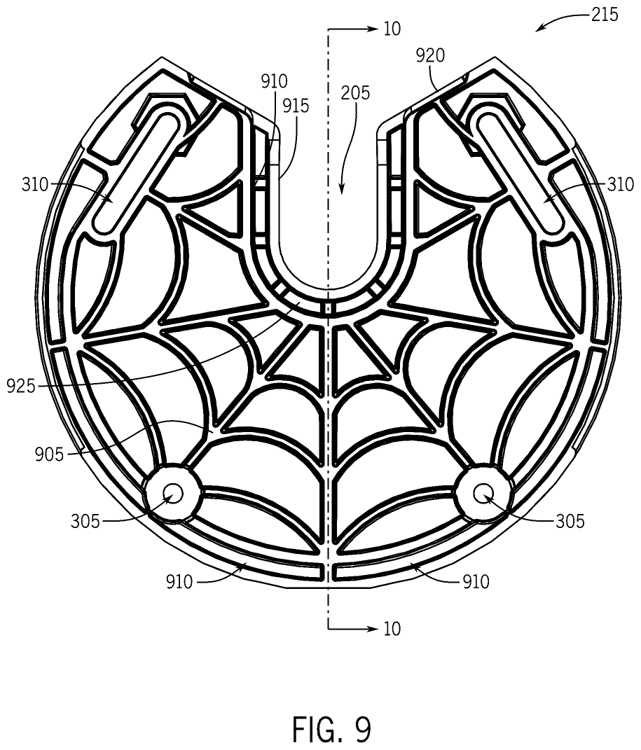

FIGS. 9-10 show an example of an interior surface 900 of the second component 215 including one or more slots 910 corresponding to the one or more tabs 705 described previously. For example, the one or more slots 910 may be configured to receive the tabs 705 such that the tabs 705 nest within the one or more slots 910. As mentioned previously, this configuration may assist in alignment of the first component 210 and the second component 215 during assembly. Additionally, this configuration may increase the overall strength and service life of the receiver 105. In another example, the second component 215 may include one or more support ribs 905, which serve to increase the overall strength of the second component 215 while reducing the overall weight of the second component 215.

In one example, the interior surface 800 of the second component 215 may define a substantially U-shaped portion adjacent the opening 205. In one example, the interior surface 800 of the second component 215 may drop off and form a wall 1005 adjacent the opening 205. In a further example, the mouth 315 of the opening 205 may include a pair of chamfered edges 920 configured to guide the mounting post into the opening 205. Extending from the wall 1005 may be a lip 925, which is positioned between the wall 1005 and a U-shaped exterior wall 915 of the opening 205. In one example, the first vertical portion 505, the angled portion 510, and the second vertical portion 515 may be arranged on the exterior wall 915.

As should be appreciated, the angle of the angled portion 510 may be varied depending on an amount of difficulty desired in removing the mounting post 110 from the receiver 105. For example, if the angle of the angled portion 510 with respect to the first vertical portion 505 is greater (e.g., nearer to perpendicular), the mounting post 110 may be harder to remove from the receiver 105. Correspondingly, if the angle of the angled portion 510 with respect to the first vertical portion 505 is smaller (e.g., nearer to parallel), the mounting post 110 may be easier to remove from the receiver 105.

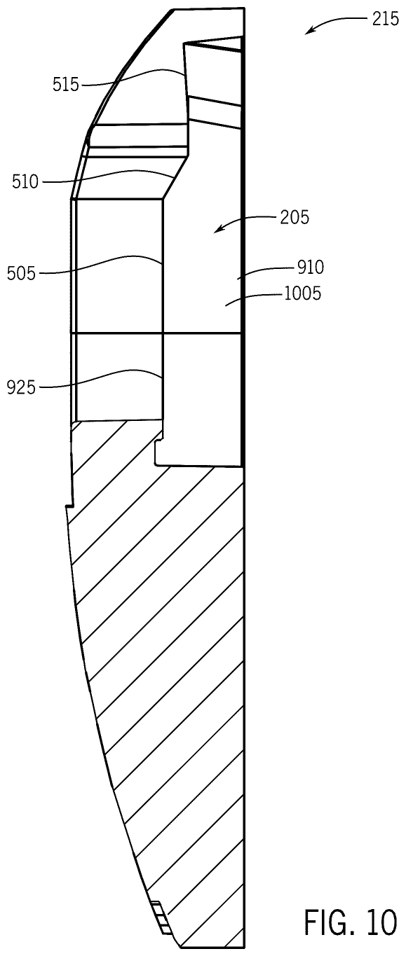

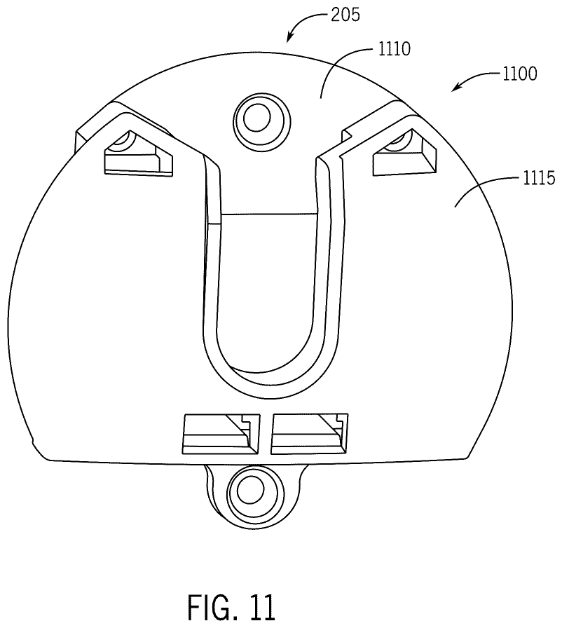

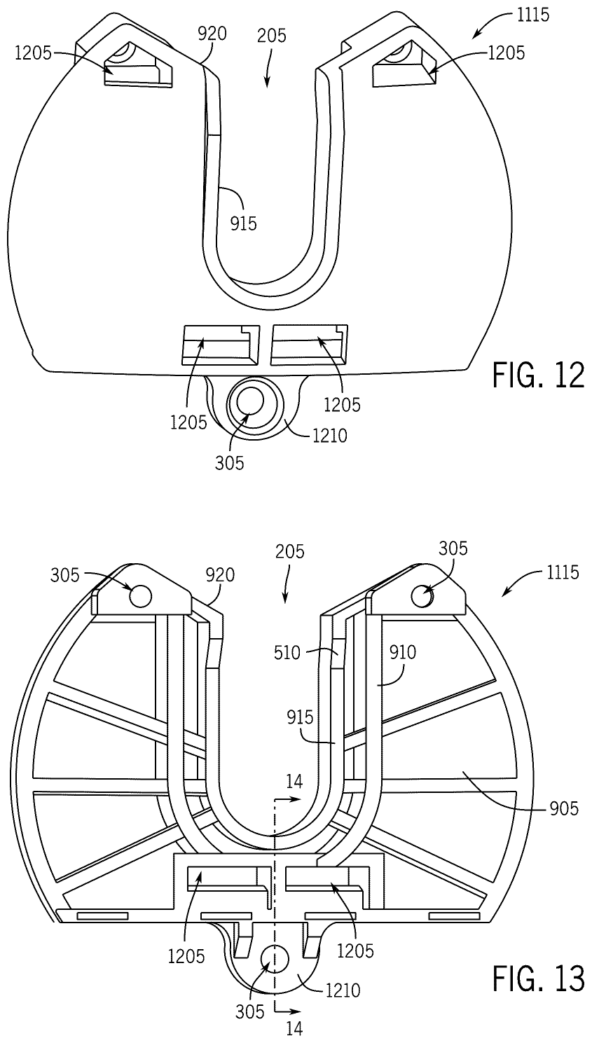

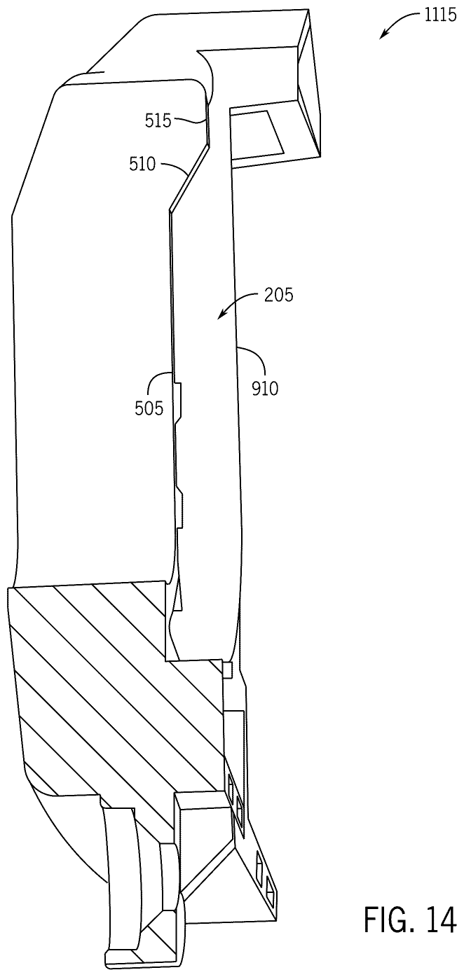

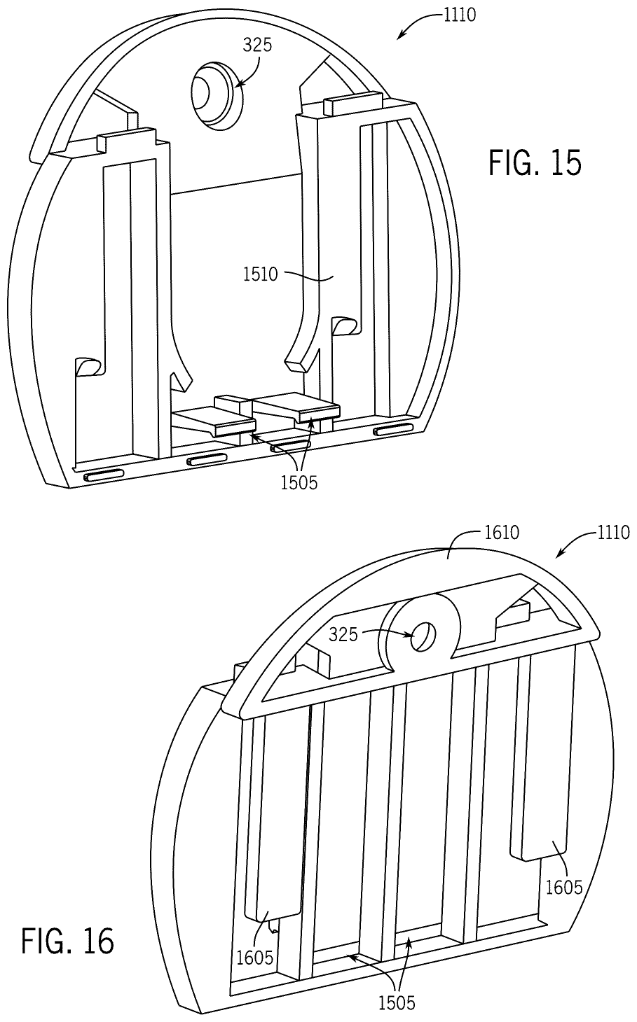

FIGS. 11-16 illustrate another example of a receiver 1100 that can be used with the equipment retention system 100 of FIG. 1 (e.g., as an alternative configuration of the receiver 105). As will be recognized, the receiver 1100 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the receiver 1100.

The receiver 1100 may include a first component 1110 and a second component 1115. In one example, the second component 1115 may include one or more retention openings 1205 configured to receive one or more hooks 1505 extending from an inner surface 1510 of the first component 1110. In one example, the hooks 1505 may be configured to engage the retention openings 1205 to selectively secure the first component 1110 to the second component 1115. For example, the hooks 1505 may extend through the retention openings 1205 and engage a portion of the second component 1115 to clamp and/or secure the first component 1110 to the second component 1115.

In one example, the second component 1115 may include a mounting tab 1210 extending from the second component 1115. The mounting tab 1210 may include the aperture 305 to enable a user to secure the receiver 1100 to an object (e.g., a wall, tree, and/or any other object) via a fastener. Correspondingly, the first component 1110 may include a ledge 1610 including the aperture 325 as described previously. In one example, one or more retention arms 1605 may extend vertically away from the ledge 1610. In one particular example, a pair of retention arms 1605 may extend parallel to and offset from each other, away from the ledge 1610. The retention arms 1605 may enable a user to secure the receiver 1100 to a strap and/or belt of a user. For example, the retention arms 1605 may enable a user to mount the receiver 1100 to a one or more MOLLE loops.

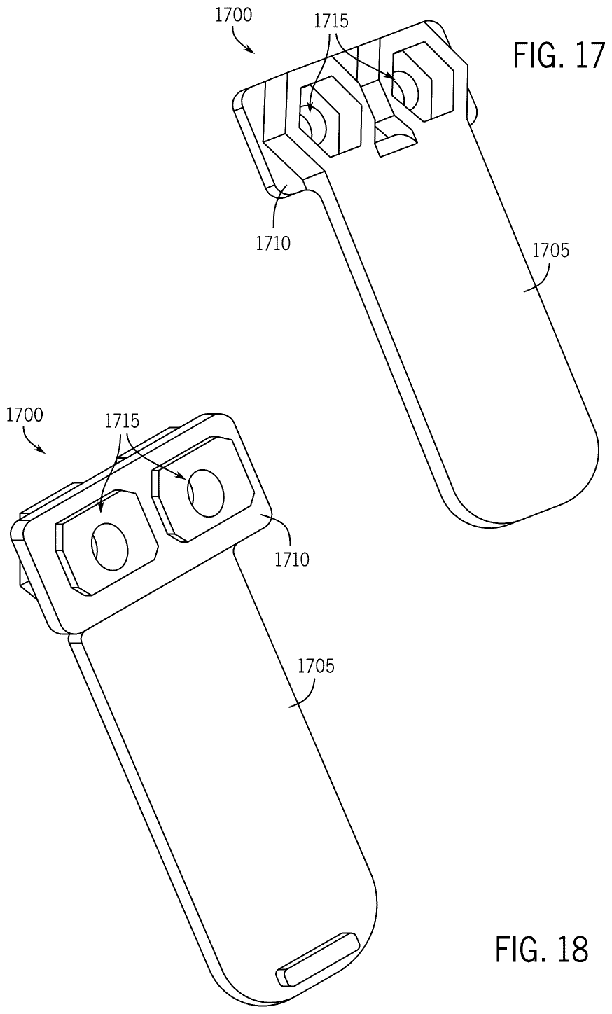

FIGS. 17-18 illustrate one example of an optional clip 1700 for use with the equipment retention system 100. In one example, a user may secure the clip 1700 to the receiver 105 to enable a user to secure the receiver 105 to a belt, strap, and/or MOLLE loop. The clip 1700 may include a head portion 1710 and a tongue portion 1705 extending from the head portion 1710. In one example, the clip 1700 may be secured to the receiver 105 via one or more fasteners arranged through one or more openings 1715 positioned on the head portion 1710 of the clip 1700. Thus, the clip 1700 may be secured to and/or removed from the receiver 105 as desired by a user. In use the tongue portion 1705 of the clip 1700 may be arranged through a strap and/or loop (e.g., MOLLE loop) to secure the receiver 105 to the strap and/or loop.

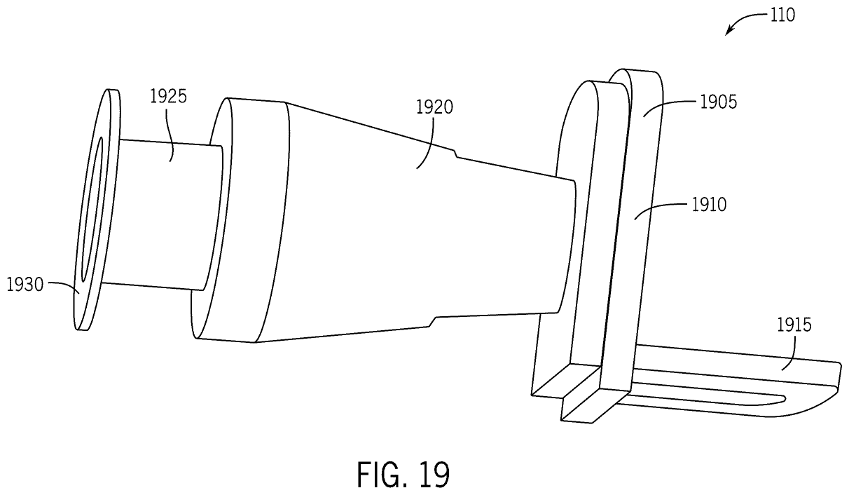

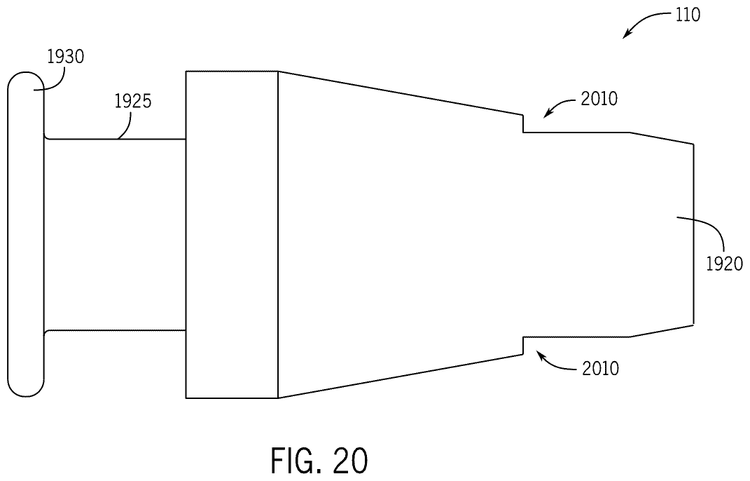

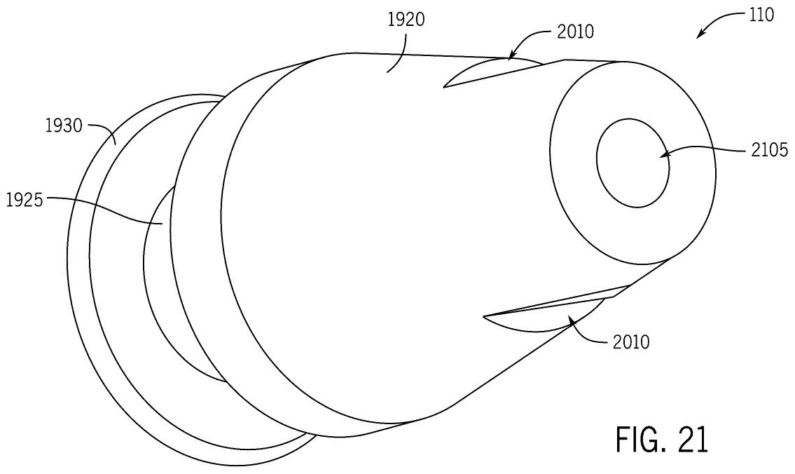

FIGS. 19-21 show one example of the mounting post 110. The mounting post 110 may include a mounting bracket 1905 configured to enable a user to secure the mounting post 110 to the object 115. The mounting bracket 1905 may include a first end 1910 and a second end 1915. The second end 1915 may enable a user to secure the mounting post 110 to the object 115 via a fastener. The first end 1910 may be integral to a body 1920 of the mounting post 110. In other examples, the first end 1910 may be secured to the body 1920 via a fastener to enable a user to add and/or remove the mounting bracket 1905 from the mounting post 110. In one example, the body 1920 may define a substantially circular cross-section, which extends into a neck 1925 with a reduced cross-section (e.g., diameter) compared to the body 1920. Correspondingly, the neck 1925 may extend into a head 1930, which has an increased cross-section (e.g., diameter) compared to the neck. Thus, both the body 1920 and the head 1930 may have a larger diameter than the neck 1925. The head 1930 may have an outer perimeter forming a rim, which may be configured to contact a portion of the receiver 105 to prevent accidental removal of the mounting post 110 from the receiver 105. In one example, the body 1920 may include one or more cutouts 2010, which may form flat portions on the body 1920. The cutouts 2010 may permit a user to grip the mounting post 110 when attaching and/or detaching the mounting post 110 to and/or from an object and/or mounting bracket 1905 via aperture 2105. For example, the aperture 2105 may enable a user to attach the mounting post 110 to an object via a fastener. In another example, the aperture 2105 may enable a user to attach the mounting post 110 to the mounting bracket 1905.

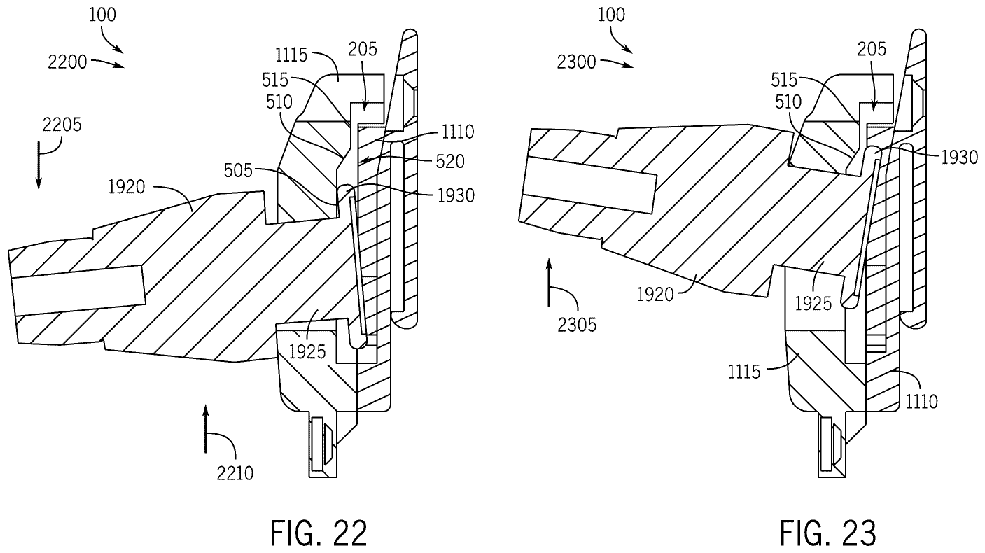

FIGS. 22-23 illustrate the equipment retention system 100 in both a locked position 2200 and an unlocked position 2300. Looking to FIG. 22, the equipment retention system 100 is shown in the locked position 2200. To reach the locked position 2200, a user first aligns the head 1930 of the mounting post 110 such that the head 1930 of the mounting post 110 is positioned within the receiver 105 (e.g., the head 1930 is within the gap 525 below the angled portion 510). Once the head 1930 of the mounting post 110 is within the gap 525 below the angled portion 510, the user may release the object 115 and/or the mounting post 110, which enables gravity to rotate the mounting post 110 (e.g., as shown by arrow 2205) about a pivot point (e.g., the head 1930) within the gap 525. Put differently, the mounting post 110 pivots about the head 1930 such that the head 1930 is angled towards the angled portion 510. Thus, in the locked position 2200, any attempted vertical movement (e.g., in direction of arrow 2210) of the mounting post 110 results in contact between the rim of the head 1930 and the angled portion 510, which prevents removal of the mounting post 110 from the receiver 105.

In one example, when the head 1930 is within the gap 525, the neck 1925 extends through the opening 205 such that the body 1920 is on an exterior of the receiver 105. Put differently, as both the head 1930 and the body 1920 have a larger diameter than the neck 1925, neither the head 1930 nor the body 1920 may pass through the opening 205, which prevents horizontal movement of the mounting post 110. Thus, when in the locked position 2200 both horizontal and vertical movement of the mounting post 110 is prevented. However, rotation of the mounting post 110 (about the head 1930) is permitted. Thus, a user must first pivot the mounting post 110 about the head 1930 to unlock the mounting post 110 prior to vertical and/or horizontal movement of the mounting post 110.

To move the mounting post 110 into the unlocked position 2300, the user rotates the head 1930 of the mounting post 110 (e.g., in the direction of arrow 2305) such that the rim of the head 1930 is angled away from the angled portion 510. Put differently, the user pivots the mounting post about the head 1930 such that vertical movement of the mounting post 110 avoids contact with the angled portion 510. Thus, the user may apply vertical force to the mounting post 110 to remove the mounting post 110 from the opening 205 and disengage the mounting post 110 from the receiver 105. However, the user must maintain the rearward tilt and/or rotation of the head 1930 during vertical movement of the mounting post 110 to remove the mounting post from the receiver 105. Thus, the transfer of the mounting post 110 from the locked position 2200 to the unlocked position 2300 does not require additional mechanical components (e.g., springs, biasing elements, etc.), which may be prone to failure and shorten an overall service life of the equipment retention system 100.

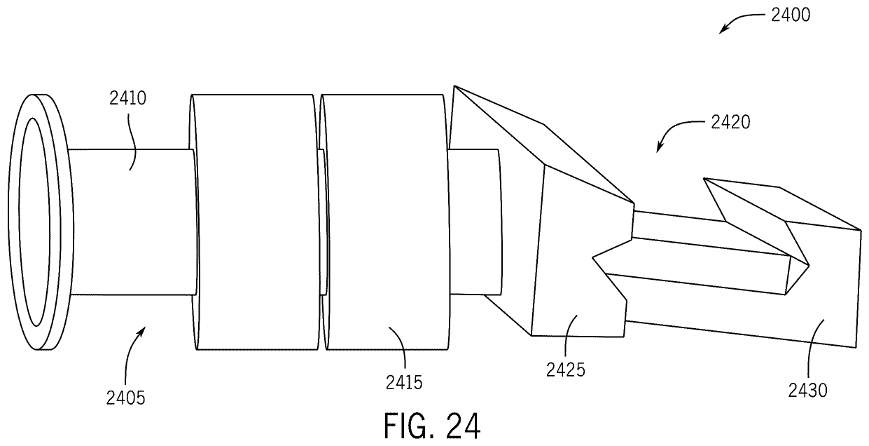

FIG. 24 illustrates another example of a mounting post 2400 that can be used with the equipment retention system 100 of FIG. 1 (e.g., as an alternative configuration of the mounting post 110). As will be recognized, the mounting post 2400 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the mounting post 2400.

The mounting post 2400 may include a post portion 2405 connected to a clamp portion 2420 via one or more spacers 2415. In one example, the clamp portion 2420 may be configured to clamp and/or secure the mounting post 2400 to an object (e.g., an archery bow, crossbow, firearm, and/or any other object. In one particular example, the clamp portion 2420 may be configured to clamp and/or secure the mounting post 2400 to a rail mounting to the object. For example, the clamp portion 2420 may secure the mounting post 2400 to a picatinny rail, weaver rail, and/or any other rail system. The post portion 2405 may include a post 2410 and the one or more spacers 2415 configured to reduce and/or increase a distance between the clamp portion 2420 and the post 2410. The clamp portion 2420 may include a base 2425, which may be secured to the one or more spacers 2415 and/or the post 2410. The clamp portion 2420 may further include a clamp 2430, which may be configured to work in combination with the base 2425 to clamp and/or secure the mounting post 2400 to the rail (e.g., picatinny rail and/or weaver rail).

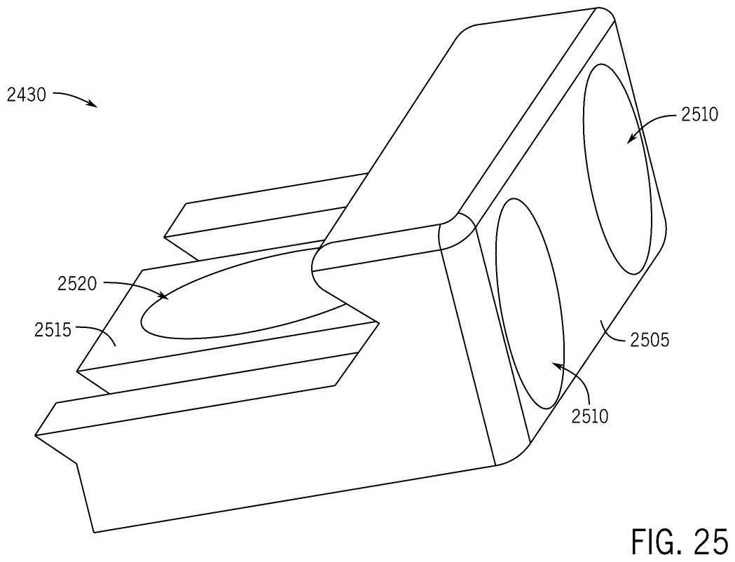

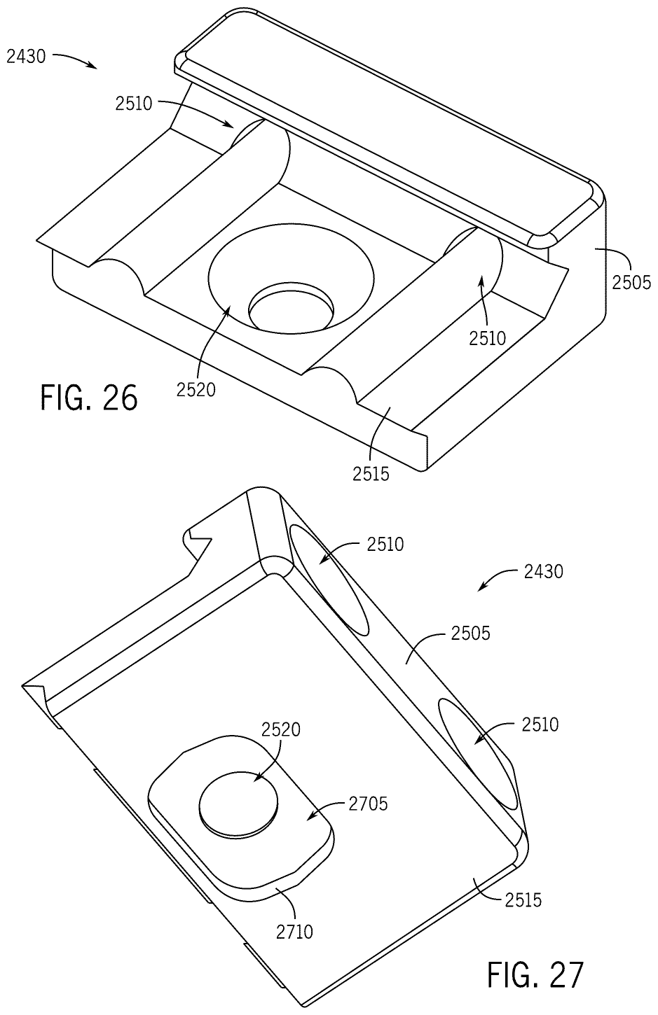

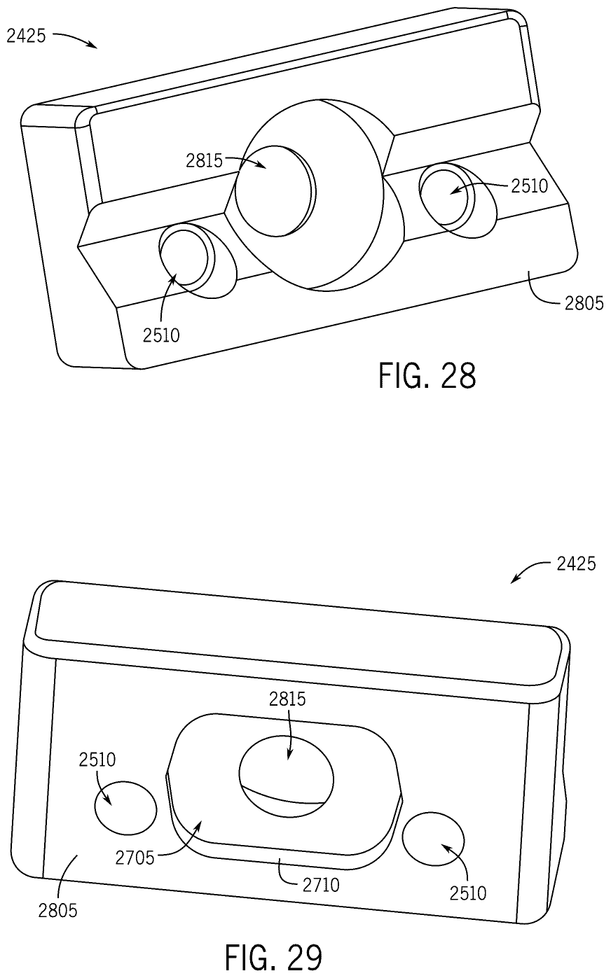

FIGS. 25-29 illustrate examples of the clamp portion 2420 including the base 2425 2420 and the clamp 2430. In one example, the clamp 2430 may include an end wall 2505 having a pair of openings 2510 extending through the end wall 2505. The clamp 2430 may further include a side wall 2515 extending substantially perpendicular from the end wall 2505. The side wall 2515 may include an opening 2520, which may be located between the openings 2510. The opening 2520 may be configured to receive a fastener to secure the clamp portion 2420 to the post portion 2405. In one example, an exterior surface of the side wall 2515 may include a debossed portion 2705, which may define a depressed flange 2710 configured to receive a corresponding embossed portion of the post 2410 and/or the one or more spacers 2415. Similar to the opening 2520 described previously, the base 2425 may include an opening 2815 arranged through a body 2805 of the base 2425. The base 2425 may further include a secondary debossed portion 2705 including a second depressed flange 2710. As should be appreciated, the openings 2815, 2520 permit a user to mount the post portion 2405 to the clamp portion 2420 at a variety of locations depending on a desired arrangement and/or configuration of the mounting post 2400.

In one example, to mount the mounting post 2400 to a rail, the base 2425 and the clamp are positioned on either side of a rail (e.g., a picatinny rail and/or weaver rail) and one or more fasteners are arranged through the openings 2510. Following this, the one or more fasteners may be tightened to clamp and/or compress the rail between the clamp 2430 and the base 2425 to secure the mounting post 2400 to the rail.

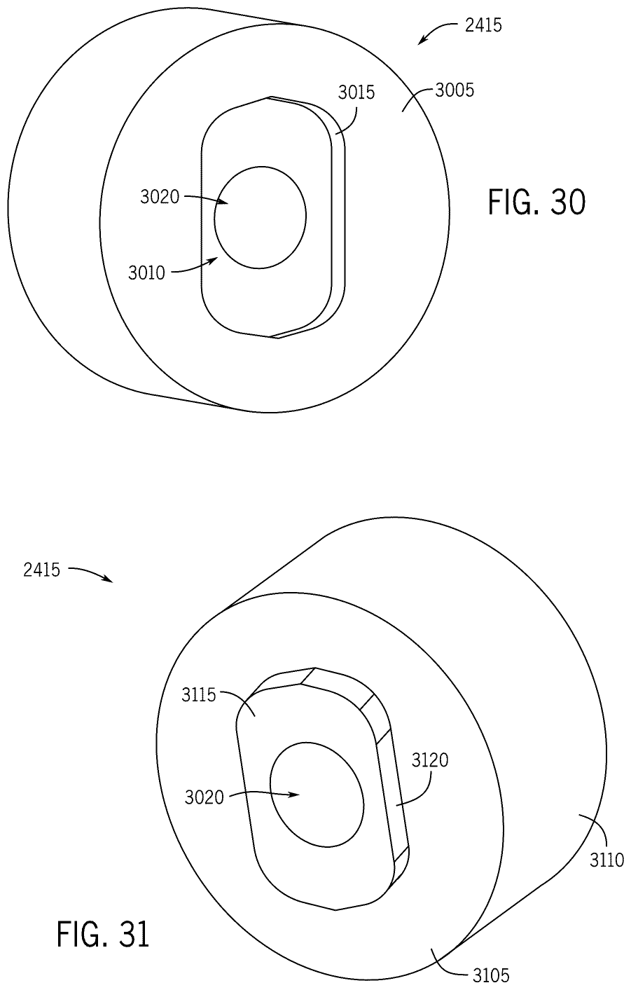

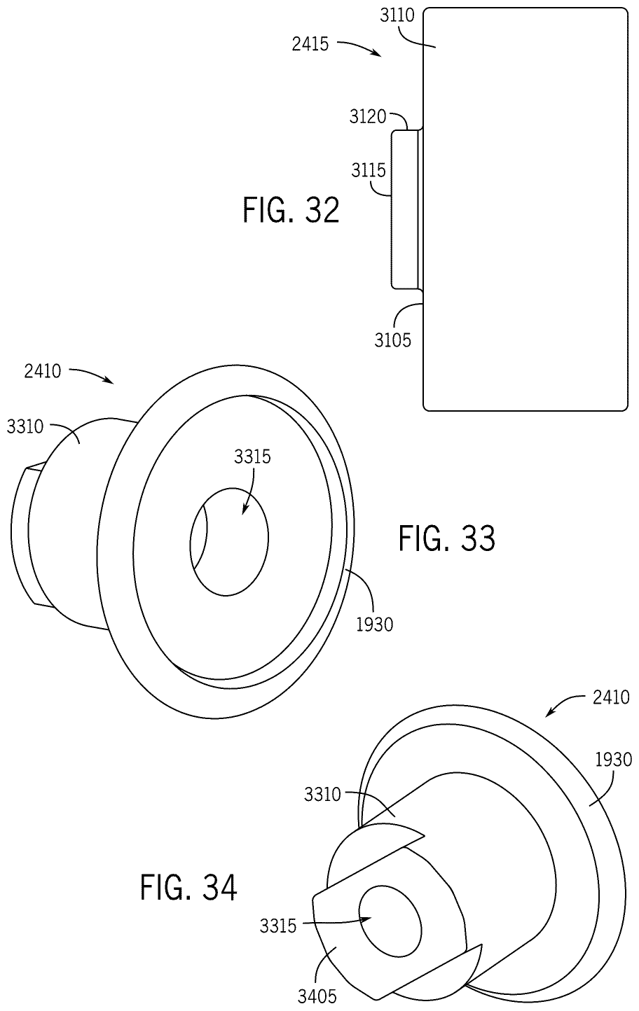

Looking to FIGS. 30-32, the spacer 2415 may include a body 3005 with a first side having a debossed portion 3010 defining a depressed flange 3015. Opposite the first side, the spacer 2415 may include an embossed portion 3115 forming a locking protrusion 3120. In one example, the spacer 2415 may further include an opening 3020 extending through the body 3005 of the spacer 2415. The opening 3020 may enable a user to pass a fastener through the spacer 2415 from the clamp portion 2420 to the post 2410 to secure the post portion 2405 to the clamp portion 2420. In one example, the spacer 2415 may increase an overall length and/or distance from the clamp portion 2420 to the post 2410, which may prevent interference between the object 115 and the receiver 105. In another example, a user may stack and/or combine multiple spacers 2415 of differing thicknesses 3110 to reach a predetermined distance between the object 115 and the receiver 105. In other examples, the user may utilize no spacers 2415 and instead directly mount the post 2410 to the clamp portion 2420.

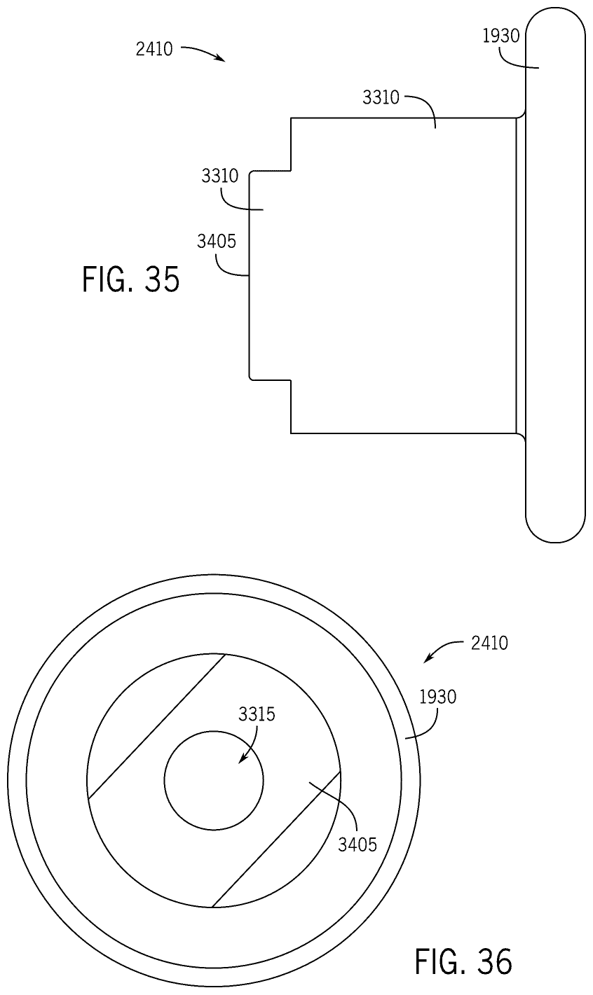

FIGS. 33-36 illustrate an example of the post 2410 including the head 1930, which extends into a neck 3310 having a reduced diameter and/or cross-section when compared to the head 1930. In one example, an opening 3315 may extend through both the head 1930 and the neck 3310 of the post 2410 to enable a user to secure the post 2410 to the clamp portion 2420 and/or the spacer 2415 via a fastener. In other examples, the opening 3315 may only extend through a portion of the neck 3310 and not extend through the head 1930. Similar to the embossed portion discussed previously, the post 2410 may include a protrusion 3405 extending from an end of the post 2410 opposite of the head 1930. The protrusion 3405 may define a complementary shape to the debossed portions discussed previously, such that the protrusion 3405 may nest within the debossed portions of the spacer 2415 and/or the clamp portion 2420. Thus, each of the post 2410, the spacers 2415, and/or the clamp portion 2420 are configured to nest together via a combination of the protrusion 3405, the embossed portions, and/or the debossed portions to provide additional strength to the mounting post 2400.

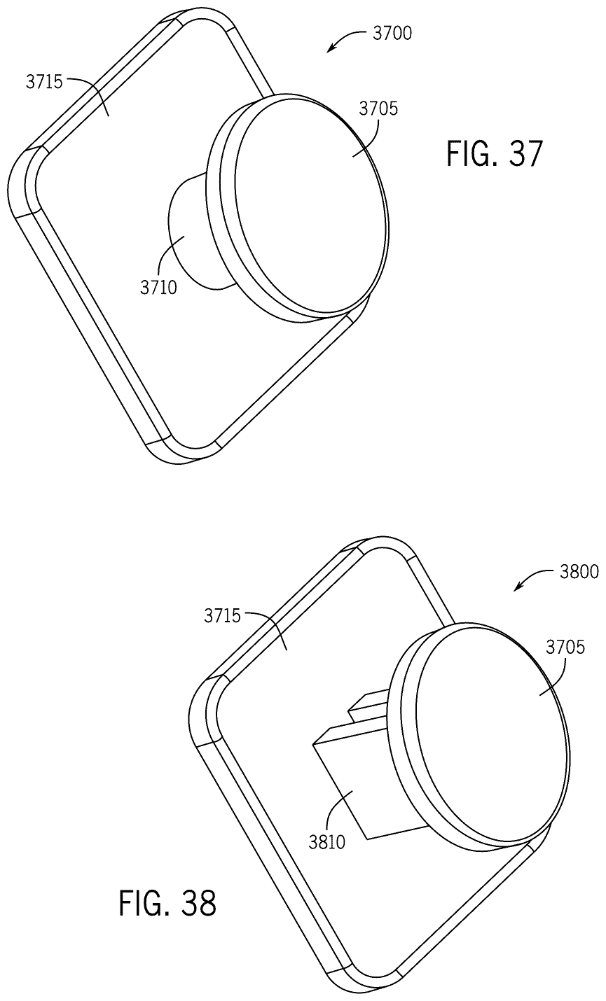

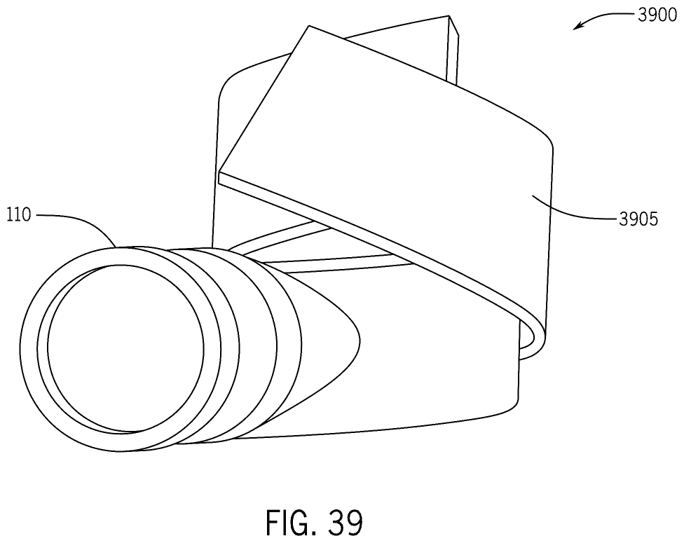

FIGS. 37-38 show examples of a mounting pin 3700 and a mounting pin 3800 for use with the equipment retention system 100. The mounting pin 3700 may include a head 3705, a neck 3710, and a base 3715. In one example, the neck 3710 may extend away from a surface of the base 3715 to the head 3705. The neck 3710 of the mounting pin 3700 may have a circular and/or ovular cross-section configured to fit within the opening 205 of the receiver 105. Thus, the mounting pin 3700 may be rotatable within the receiver 105 due to the circular and/or ovular cross-section. In the example shown in FIG. 38, the mounting pin 3800 may include a neck 3810 having a rectangular cross-section. The rectangular cross-section of the neck 3810 of the mounting pin 3800 may restrict rotation of the mounting pin 3800 within the receiver 105. Thus, a user may select cither mounting pin 3700 and/or mounting pin 3800 depending on whether or not rotation of the mounting pin (and thus object 115) when secured within the receiver 105 is desired.

FIG. 39 shows an example of a mounting post assembly 3900. The mounting post assembly 3900 includes the mounting post 110 secured to a strap 3905. In one example, the strap 3905 may include hook and loop fasteners to enable a user to secure the mounting post 110 to any desired object without the need for external and/or additional fasteners. Thus, the mounting post assembly 3900 may enable a user to quickly and non-permanently secure the mounting post 110 to any object desired for supporting the object 115 via the receiver 105.

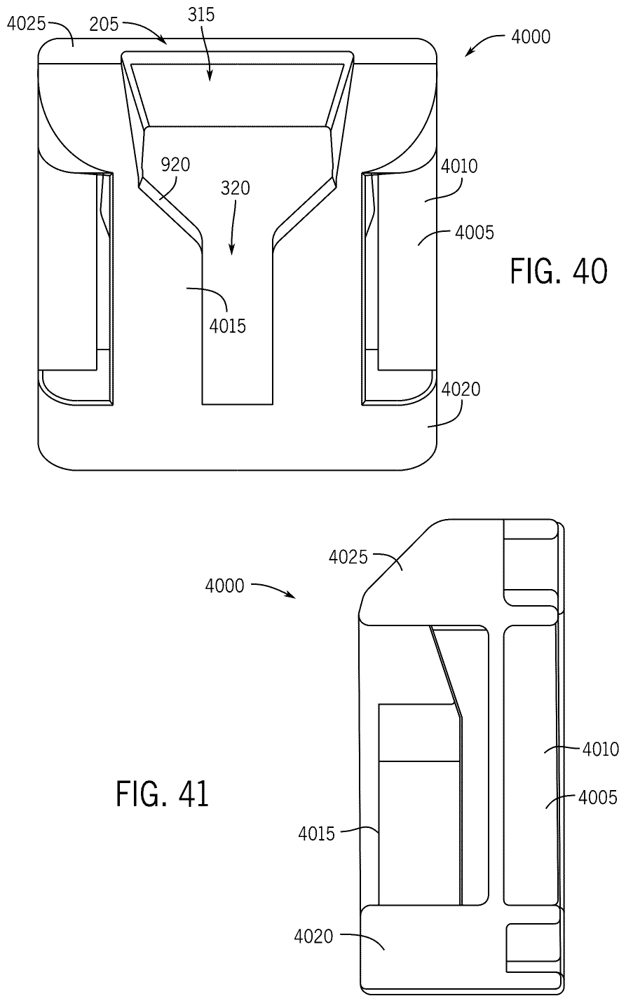

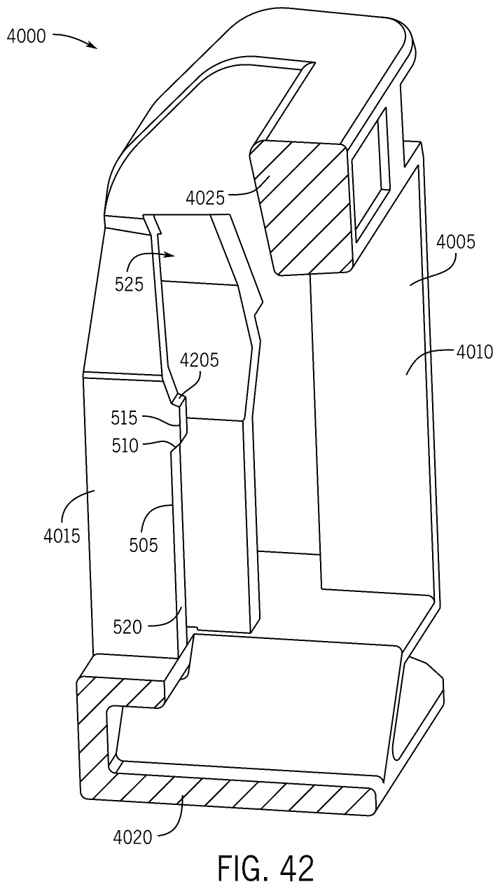

FIGS. 40-42 illustrate another example of a receiver 4000 that can be used with the equipment retention system 100 of FIG. 1 (e.g., as an alternative configuration of the receiver 105). As will be recognized, the receiver 4000 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the receiver 4000.

In one example, the receiver 4000 may be in the form of a one-piece and/or unitary molded receiver. For example, the receiver 4000 may have a body 4005 defining a single, unitary form with a first component 4010 integrally formed with a second component 4015. Thus, the receiver 4000 may be formed without the need for additional fasteners, components, and with reduced maintenance overall.

In one example, the first component 4010 and the second component 4015 may be interconnected at a first end and a second end of the receiver 4000 via a base 4020 and a header 4025 to form the gap 525 configured to receive the mounting post 110. In one particular example, the receiver 4000 may be integrally formed via 3D printing, casting, injection molding, and/or any other known process. Further, the receiver 4000 may be made from metallic materials, polymeric materials, and/or any combination thereof.

To facilitate insertion of the mounting post 110 into the opening 205, the interior surface 520 of the receiver 4000 may include a beveled edge 4205 configured to ramp and/or guide the head of the mounting post 110 into the neck 320 of the receiver during insertion of the mounting post 110 into the receiver 4000.

As should be appreciated, any of the above-describe equipment retention systems, including various examples of the receivers and mounting posts may be interchangeable as desired by a user. For example, the mounting posts (or mounting pins) shown in FIGS. 24-39, among other FIGS. may be utilized with any of the receivers described herein (e.g., receivers shown in FIGS. 2-16, among others). Thus, the above-described equipment retention systems may be modular, with a variety of the described mounting posts (or pins) being usable with a variety of the described receivers, as desired by a user for a particular use case. Further, the method of locking/unlocking the mounting post from the receiver described with respect to FIGS. 22 and 23 may be utilized with any combination of the various receivers and/or mounting posts as descried herein and is not limited to merely the illustrated example shown in FIGS. 22 and 23.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An equipment retention system, comprising:
a receiver including a first component and a second component secured to the first component; and
a mounting post having a first end and a second end, the mounting post selectively engaged with the receiver via the first end and fixedly secured to an object via the second, opposite, end;
wherein the receiver defines a substantially Y-shaped opening configured to selectively receive the first end of the mounting post; and
wherein, upon insertion of the first end of the mounting post into the Y-shaped opening, the mounting post is locked within the Y-shaped opening via engagement between a head of the mounting post and an angled protrusion extending away from a surface of the second component of the receiver.

2. The equipment retention system of claim 1, wherein the Y-shaped opening includes a chamfered edge to guide the first end of the mounting post into the Y-shaped opening.

3. The equipment retention system of claim 2, wherein the Y-shaped opening includes a U-shaped slot to receive the first end of the mounting post.

4. The equipment retention system of claim 1, wherein the receiver includes a slot to permit the insertion of a strap through the receiver.

5. The equipment retention system of claim 3, wherein the U-shaped slot includes an exterior wall to retain the first end of the mounting post.

6. The equipment retention system of claim 5, wherein the exterior wall defines a stepped profile, with an angled protrusion configured to retain the first end of the mounting post within the receiver.

7. The equipment retention system of claim 6, wherein rotation of the mounting post in a first direction locks the mounting post within the receiver via contact between the first end of the mounting post and the angled protrusion.

8. The equipment retention system of claim 7, wherein rotation of the mounting post in a second direction unlocks the mounting post from the receiver and reduces contact between the first end of the mounting post and the angled protrusion.

9. The equipment retention system of claim 1, wherein a second end of the mounting post includes a picatinny rail mounting system.

10. The equipment retention system of claim 9, wherein a second end of the mounting post includes a hook and loop strap.

11. A method of using an equipment retention system, the method comprising:
arranging a head of a mounting post within a gap defined by a receiver, with the head of the mounting post positioned below an angled portion of the gap of the receiver;
releasing the mounting post to permit rotation of the head of the mounting post within the gap of the receiver in a first direction to move the mounting post into a first position; and
preventing removal of the mounting post from the gap of the receiver via contact between the head of the mounting post and the angled portion of the gap of the receiver when in the first position.

12. The method of claim 11, further comprising:
rotating the mounting post in a second direction to move the mounting post into a second position;
when the mounting post is in the second position, moving the head of the mounting post out of contact with the angled portion of the gap of the receiver; and
permitting removal of the mounting post from the gap of the receiver when in the second position.

13. The method of claim 11, wherein the receiver defines a substantially Y-shaped opening configured to selectively receive the first end of the mounting post.

14. The method of claim 11, wherein a second end of the mounting post includes a picatinny rail mounting system.

15. The method of claim 11, wherein a second end of the mounting post includes a hook and loop strap.

16. An equipment retention system, comprising:
a mounting post, including:
a head defining a first end;
a neck secured to and extending away from the head; and
a body secured to and extending from the neck, the body defining a second end configured to retain an object; and
a receiver, the receiver to selectively receive and retain the mounting post, the receiver including:
a first component; and
a second component secured to the first component, the first component and the second component together defining a gap to receive the head of the mounting post, and the second component defining a chamfered edge to guide the mounting post into the gap;
wherein the second component includes a stepped inner surface having an angled protrusion extending within the gap, towards the first component, the angled protrusion to contract the head of the mounting post to selectively retain the mounting post within the gap.

17. The equipment retention system of claim 16, wherein the object is one of:
an archery bow;
a crossbow;
a firearm; or
an optic.

18. The equipment retention system of claim 16, wherein the head defines a first diameter, the neck defines a second diameter, and the body defines a third diameter, and wherein the second diameter of the neck is smaller than the first diameter of the head and the third diameter of the body.

19. The equipment retention system of claim 18, wherein, when the head is positioned within the gap, the neck extends through a U-shaped slot within the second component, with the head preventing movement of the mounting post in a first direction.

20. The equipment retention system of claim 19, wherein, when the head is positioned within the gap, contact between the head and the angled protrusion prevents movement of the mounting post in a second direction, when the mounting post is in a first position; and
when the head is positioned within the gap, rotation of the mounting post into a second position reduces contact between the head and the angled protrusion to permit movement of the mounting post in the second direction, but not the first direction.
